(19) United States
(12) Patent Application Publication
(10) Pub. No.: US 2007/0099165 A1
(43) Pub. Date: May 3, 2007

(54) Method and system for computer assisted training and credentialing with follow-up control

(75) Inventors: Marc Moesges, Heidelberg (DE); Holger Bohle, Dielheim (DE); Marcus Philipp, Dielheim (DE); Stefan Schuessler, Heidelberg (DE)

Correspondence Address: COOPER & DUNHAM, LLP, 1185 AVENUE OF THE AMERICAS, NEW YORK, NY, 10036, US

(73) Assignee: SAP AG

(21) Appl. No.: 11/262,603

(22) Filed: Oct. 31, 2005

(51) Int. Cl. G09B 3/00

(52) U.S. Cl. 434/350; 434/362

(57) ABSTRACT

A method for computer assisted training and credentialing includes providing a training session, taught by an instructor, or a computer program acting as an instructor, to one or more participants. One or more process steps are executed at corresponding entry points to provide credentialing of those of the one or more participants who are deemed to have satisfactorily participated in the training session.

### BACKGROUND

1. Technical Field

The present disclosure relates to training and, more specifically, to computer assisted training and credentialing with follow-up control.

2. Description of the Related Art

Human Capital Management (HR) systems, also known as HR systems, are computerized solutions used by enterprises to effectively manage pools of human capital. HR systems are commonly integrated into a broader suit of Enterprise Resource Planning (ERP) applications that integrate information from a diverse set of applications into a singular database. One prime example of an ERP solution is “mySAP” or “SAP R/3” offered by SAP.

One function of HR systems is to keep track of the qualifications of employees. As employees participate in various training sessions, either company sponsored or otherwise, the record of the participant's qualifications may require updating.

As is the case in certain regulated fields, employees may be periodically required by law to satisfactorily participate in various training sessions.

Administering the training programs, accreditation/credentialing, and follow-up procedures can be a logistical challenge, especially for organizations with a large number of employees. It is therefore desirable to implement a system and method for computer assisted training and credentialing with follow-up control. It may be additionally desirable for such a system and method to be integrated with, and build off of an HR system, for example an existing HR system.

### SUMMARY

A method for computer assisted training and credentialing includes providing a training session, taught by an instructor or a computer program acting as an instructor (e.g. a player playing course content and tracking the progress of a learner), to one or more participants. One or more process steps are executed at corresponding entry points to provide credentialing of those of the one or more participants who are deemed to have satisfactorily participated in the training session.

A system for computer assisted training and credentialing, includes an instructor for providing a training session to one or more participants and an executing unit for executing one or more process steps at corresponding entry points to provide credentialing of those of the one or more participants who are deemed to have satisfactorily participated in the training session.

A computer system includes a processor and a program storage device readable by the computer system, embodying a program of instructions executable by the processor to perform method steps for computer assisted training and credentialing. The method includes providing a training session, taught by an instructor or a computer program acting as an instructor (e.g. a player playing course content and tracking the progress of a learner), to one or more participants, wherein one or more process steps are executed at corresponding entry points to provide credentialing of those of the one or more participants who are deemed to have satisfactorily participated in the training session.

### BRIEF DESCRIPTION OF THE DRAWINGS

A more complete appreciation of the present disclosure and many of the attendant advantages thereof will be readily obtained as the same becomes better understood by reference to the following detailed description when considered in connection with the accompanying drawings, wherein:

FIG. 1 shows a system for computer assisted training and credentialing with follow-up control according to an embodiment of the present disclosure;

FIG. 2 shows an example of a system table according to an embodiment of the present disclosure;

FIG. 3 shows an example of a system table with customized fields according to an embodiment of the present disclosure;

FIG. 4 is a table showing descriptions of various processes when assigned to various entry points according to an embodiment of the present disclosure; and

FIG. 5 shows an example of a computer system capable of implementing the method and apparatus according to embodiments of the present disclosure.

### DETAILED DESCRIPTION

In describing the preferred embodiments of the present disclosure illustrated in the drawings, specific terminology is employed for sake of clarity. However, the present disclosure is not intended to be limited to the specific terminology so selected, and it is to be understood that each specific element includes all technical equivalents which operate in a similar manner.

Training is an important part of employee development and in certain regulated fields, for example pharmaceutical production, certain employees may be legally obliged to satisfactorily participate in various training sessions.

It may be desirable for an organization to keep a record of the various qualifications and proficiencies of employees, for example, so that employees can be effectively matched with positions and fulfillment of training obligations, be they legally mandated or internally mandated, may be accurately assessed.

Because of the large administrative burden these tasks may carry, administration of training and credentialing may be computer assisted, for example using an HR system.

Employees and other individuals may participate in training sessions. After the conclusion of the training sessions, sets of activities called “follow-ups” may be implemented to verify the effectiveness of the training session and to apply the appropriate credentials to the participant's record. Some follow-up activities are directed directly to the participant, while other follow-up activities are directed to the instructor of the training in case the training is a instructor led training (ILT). One or more administrators may also have follow-up activities directed to them.

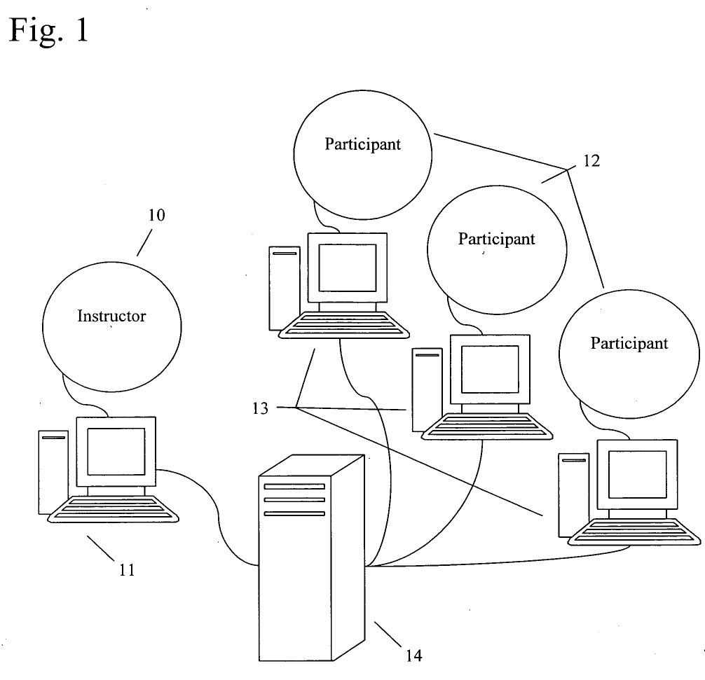

FIG. 1 shows a system for computer assisted training and credentialing with follow-up control according to an embodiment of the present disclosure. An instructor 10 at an instructor's terminal 11 may conduct a training session with one or more participants 12 in attendance. Each participant may use participant's terminals 13. The instructor's terminal 11 and the participant's terminals 13 may be connected to one or more servers 14, for example, an HR server.

Follow-up processes may include imparting qualifications to the participant's record. The record may be, for example, the entry of qualifications objects to a database object representing the participant. Follow-up processes may also include historization of the training course, billing and/or cost accounting.

The follow-up process may have multiple steps. For example, the first step may be to confirm participation. Confirming participation may be, for example, recording whether the participant was actually present at the training session. The next step may be to evaluate participation. This may be, for example, to assess the participation of the participant. Assessing the participation of the participant may include determining whether the participant has or has not satisfactorily participated in the training session. For example, it may be determinate whether the participant has passed or failed the training session. This assessment may be conducted either subjectively, for example, by examination, or objectively, for example, by soliciting the decision of the instructor. Where it is determined that the participant has failed, the instructor may also be required to provide an explanation/reason for the failure. The next step may be, for example, follow-up training course. Follow-up training course may include application of qualifications, proficiencies and/or credentials to the participant's record. Determining what qualifications, proficiencies and/or credentials to apply may be partially or fully dependent on an instructor's appraisal of the participant's participation. A final optional step may be confirmation of changes with digital signature. For example, where required by law, qualifications, proficiencies and/or credentials may be set to require a digital signature, for example, an E-Signature, prior to application.

The various people discussed above may each be assigned one or more steps. For example, the training session participants may be required to confirm their participation. The instructor may assess participation. The administrator may be responsible for follow-up participation. Alternatively, or additionally, the participants may themselves assess participation by submitting to an examination, for example, on the system of the present disclosure. Additionally, more that one person may be charged with the same step so that information may be corroborated.

The various people may each be required to interface with the computerized system, for example, the HR system at various stages. People may enter information into the HR system via one or more specialized entry points. An entry point may be a portal. A portal may be a customized user interface specially designed for collecting the required information. The portals may be implemented using customized applications and/or as internet and/or intranet sites.

For example, the participant may have access to a “learn portal” where the participant may enter required information. The instructor may have access to an “instructor portal” where the instructor may enter required information. The Administrator may have access to an “administrator portal” entry point where the administrator may implement required actions. Actions may also be implemented automatically at a system entry point.

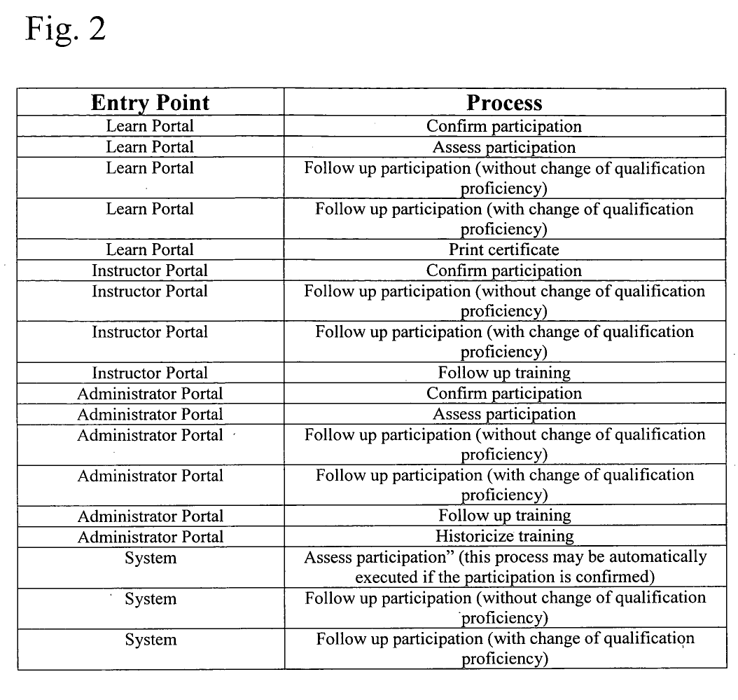

A system table may be utilized to define what actions, or processes, are required of each portal. FIG. 2 is an example of a system table according to an embodiment of the present disclosure. The relationship between entry points and processes may be static and non-customizable. From this example table, it can be seen that at the “learn portal” the participant may be required to “confirm participation,” “assess participation,” “follow up participation (without change of qualification proficiency),” “follow up participation (with change of qualification proficiency),” and “print certificate.”

At the “instructor portal,” the instructor may be required to “confirm participation,” “follow up participation (without change of qualification proficiency),” “follow up participation (with change of qualification proficiency),” and “follow up training.”

At the “administrator portal”, the administrator may be required to “confirm participation,” “assess participation,” “follow up participation (without change of qualification proficiency),” “follow up participation (with change of qualification proficiency),” “follow up training,” and “historicize training.”

At the system level, the HR system may “assess participation” (this process may be automatically executed if the participation is confirmed), follow up participation (without change of qualification proficiency)” (this process may be automatically executed if the participation is assessed positive), and “follow up participation (with change of qualification proficiency)” (this process may be automatically executed if all participations are followed up).

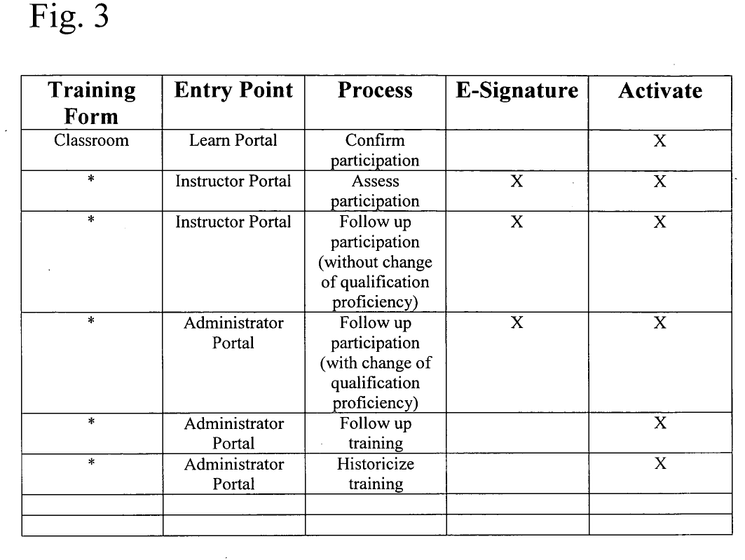

While the relationship between entry points and processes may be defined in the system table and may be static and non-customizable, other features may be customizable on a training form or training level. FIG. 3 is an example of a system table with customized fields according to an embodiment of the present disclosure. For example, specific entry points and processes may be related to a particular training form (for example, online test, classroom training, instructor led training, etc.). This relationship may be defined in the system table by adding a column called “Training Form” under which a particular training form may be related for each desired row. A training form may be used to define a specific form that the person is presented with for entering required information. One example of a training form is a “classroom” training form. The classroom training form may be adapted for use in the classroom setting.

Another example of a customization is to include an E-Signature column in the system table. Then, the E-Signature field may be either flagged or not flagged depending on whether an e-signature is to be required of the person at that process step. For example, the E-Signature field may be flagged at entry point “learn portal”, process “confirm participation” to require the participant to confirm participation using an E-Signature digital signature.

Another example of a customization is to include an “Activate” column in the system table. Then, the activate field may be either flagged or not flagged depending on whether that process is to be performed or skipped, respectively.

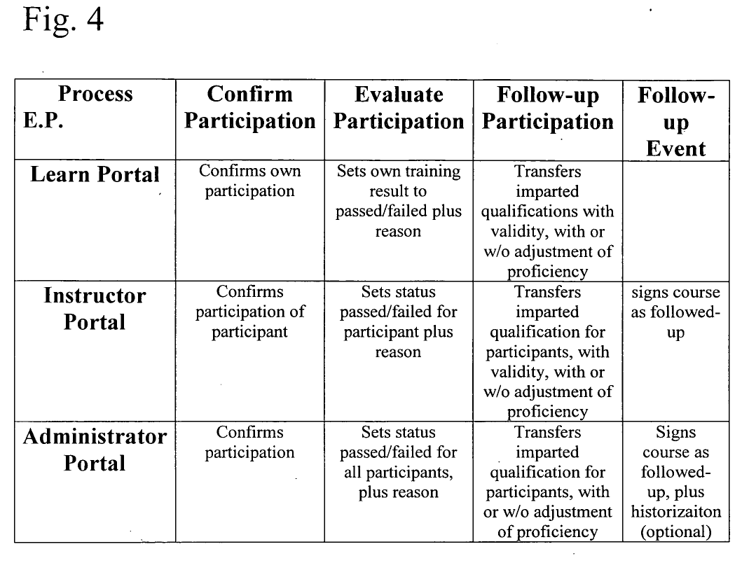

FIG. 4 is a table showing descriptions of various processes when assigned to various entry points (E.P.) according to an embodiment of the present disclosure. For example, the process “confirm participation” when assigned to the “learn portal” may be used by the participant to confirm the participant's own participation. For example, the process “confirm participation” when assigned to the “instructor portal” may be used by the instructor to confirm the participation of the participant(s). For example, the process “confirm participation” when assigned to the “administrator portal” may be used by the administrator to confirm the participation of the participant(s).

For example, the process “evaluate participation” when assigned to the “learn portal” may be used by the participant to set the participant's own training result to passed/failed plus a reason for failure (where applicable). For example, the process “evaluate participation” when assigned to the “instructor portal” may be used by the instructor to set the participant's training result to passed/failed plus a reason for failure (where applicable). For example, the process “evaluate participation” when assigned to the “administrator portal” may be used by the administrator to set the participant's training result to passed/failed plus a reason for failure (where applicable).

For example, the process “follow-up participation” when assigned to the “learn portal” may be used by the participant to transfer the participant's own imparted qualifications with validity, with or without adjustment of proficiency. For example, the process “follow-up participation” when assigned to the “instructor portal” may be used by the instructor to transfer the participant's imparted qualifications with validity, with or without adjustment of proficiency. For example, the process “follow-up participation” when assigned to the “administrator portal” may be used by the administrator to transfer the participant's imparted qualifications with validity, with or without adjustment of proficiency.

For example, the process “follow-up event” when assigned to the “instructor portal” may be used by the instructor to sign a course as followed-up. For example, the process “follow-up event” when assigned to the “administrator portal” may be used by the administrator to sign a course as followed-up and perform historization, accreditation and/or credentialing, where appropriate.

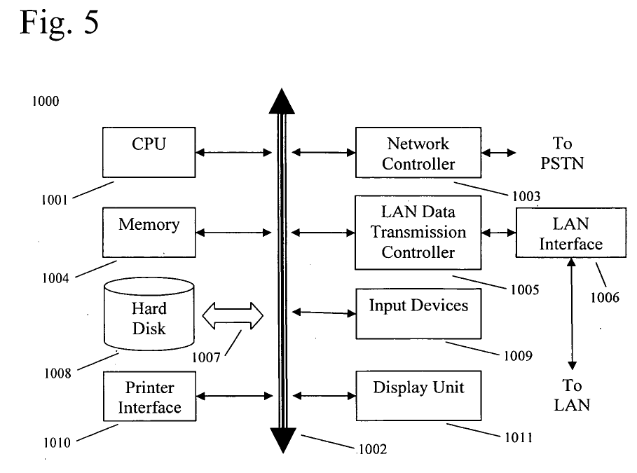

FIG. 5 shows an example of a computer system which may implement the method and system of the present disclosure. The system and method of the present disclosure may be implemented in the form of a software application running on a computer system, for example, a mainframe, personal computer (PC), handheld computer, server, etc. The software application may be stored on a recording media locally accessible by the computer system and accessible via a hard wired or wireless connection to a network, for example, a local area network, or the Internet.

The computer system referred to generally as system 1000 may include, for example, a central processing unit (CPU) 1001, random access memory (RAM) 1004, a printer interface 1010, a display unit 1011, a local area network (LAN) data transmission controller 1005, a LAN interface 1006, a network controller 1003, an internal bus 1002, and one or more input devices 1009, for example, a keyboard, mouse etc. As shown, the system 1000 may be connected to a data storage device, for example, a hard disk, 1008 via a link 1007.

The above specific embodiments are illustrative, and many variations can be introduced on these embodiments without departing from the spirit of the disclosure or from the scope of the appended claims. For example, elements and/or features of different illustrative embodiments may be combined with each other and/or substituted for each other within the scope of this disclosure and appended claims.

What is claimed is:

1. A method for computer assisted training and credentialing, comprising providing a training session, taught by an instructor or a computer program acting as an instructor, to one or more participants, wherein one or more process steps are executed at corresponding entry points to provide credentialing of those of the one or more participants who are deemed to have satisfactorily participated in the training session.

2. The method of claim 1, wherein a system table is used to define the one or more process steps and their corresponding entry points.

3. The method of claim 1, wherein the corresponding entry points may be a “learn portal” entry point, an “instructor portal” entry point, an “administrator portal” entry point, or a “system” entry point.

4. The method of claim 1, wherein one or more training forms are used to define how data is entered at one or more entry points.

5. The method of claim 1, wherein an E-Signature may be required of one or more process steps.

6. The method of claim 1, wherein only the process steps that are flagged as “active” are executed.

7. The method of claim 1, wherein the execution of the one or more process steps is implemented by an HR system.

8. A system for computer assisted training and credentialing, comprising:
an instructor, or a computer program acting as an instructor, for providing a training session to one or more participants; and
an executing unit for executing one or more process steps at corresponding entry points to provide credentialing of those of the one or more participants who are deemed to have satisfactorily participated in the training session.

9. The system of claim 8, wherein a system table is used to define the one or more process steps and their corresponding entry points.

10. The system of claim 8, wherein the corresponding entry points may be a “learn portal” entry point, an “instructor portal” entry point, an “administrator portal” entry point, or a “system” entry point.

11. The system of claim 8, wherein one or more training forms are used to define how data is entered at one or more entry points.

12. The system of claim 8, wherein an E-Signature may be required of one or more process steps.

13. The system of claim 8, wherein only the process steps that are flagged as “active” are executed.

14. The system of claim 8, wherein the execution of the one or more process steps is implemented by an HR system.

15. A computer system comprising:
a processor; and
a program storage device readable by the computer system, embodying a program of instructions executable by the processor to perform method steps for computer assisted training and credentialing, the method comprising:
providing a training session, taught by an instructor, or a computer program acting as an instructor, to one or more participants, wherein one or more process steps are executed at corresponding entry points to provide credentialing of those of the one or more participants who are deemed to have satisfactorily participated in the training session.

16. The computer system of claim 15, wherein a system table is used to define the one or more process steps and their corresponding entry points.

17. The computer system of claim 15, wherein the corresponding entry points may be a “learn portal” entry point, an “instructor portal” entry point, an “administrator portal” entry point, or a “system” entry point.

18. The computer system of claim 15, wherein one or more training forms are used to define how data is entered at one or more entry points.

19. The computer system of claim 15, wherein an E-Signature may be required of one or more process steps.

20. The computer system of claim 15, wherein only the process steps that are flagged as “active” are executed.

21. The computer system of claim 15, wherein the execution of the one or more process steps is implemented by an HR system.
